(19) United States
(12) Patent Application Publication
(10) Pub. No.: US 2016/0326933 A1
(43) Pub. Date: Nov. 10, 2016

(54) CONTROL DEVICE FOR INTERNAL COMBUSTION ENGINE

(71) Applicant: TOYOTA JIDOSHA KABUSHIKI KAISHA, Toyota-shi, Aichi (JP)

(72) Inventor: Yoshihisa SHINODA, Susono-shi (JP)

(73) Assignee: TOYOTA JIDOSHA KABUSHIKI KAISHA, Toyota-shi, Aichi (JP)

(21) Appl. No.: 15/111,945

(22) PCT Filed: Jan. 8, 2015
(86) PCT No.: PCT/JP2015/050992

§ 371 Date: Jul. 15, 2016

(30) Foreign Application Priority Data
Jan. 17, 2014 (JP) 2014-006761

(51) Int. Cl. F01N 9/00; F02D 41/02; F02D 35/02; F01N 3/20

(52) U.S. Cl. CPC F01N 9/00; F01N 3/206; F02D 41/024; F02D 35/02; F01N 2570/14; F01N 2900/08

(57) ABSTRACT

The control device simultaneously starts rich-spike operations for two cylinder groups. When starting the rich-spike operations, the amounts of reducing agent to be introduced into NSR catalysts connected to the respective banks are calculated. It is determined whether or not a difference between the reducing agent amounts is small. If it is determined that the reducing agent amount difference is less than or equal to a threshold value, target air-fuel ratios for the two banks are set to the same value. If it is determined that the reducing agent amount difference exceeds the threshold value, the target air-fuel ratios for a first bank and a second bank are set to different values. By this means, rich-spike operations for the first bank and the second bank are terminated at the same time.

### TECHNICAL FIELD

The present invention relates to a control device for an internal combustion engine. More specifically, the present invention relates to a control device for an internal combustion engine that purifies nitrogen oxides (NOx) contained in exhaust gas using catalysts.

### BACKGROUND ART

As described in, for example, Patent Literature 1 a device has already been disclosed that, in an internal combustion engine that performs lean-burn operation, when simultaneously setting air-fuel ratios of two cylinder groups to a rich side relative to a stoichiometric ratio and executing rich-spike operations at the same time, sets a time period (rich time period) in which the air-fuel ratio is set to the rich side for each cylinder group. The internal combustion engine includes two NOx catalysts that correspond to the two cylinder groups. Each NOx catalyst has a function of storing NOx during lean-burn operation of the internal combustion engine and reducing NOx during rich-burn operation of the internal combustion engine. By setting a rich time period for each cylinder group, NOx stored in the respective NOx catalysts can be separately reduced and purified during a rich-spike operation.

Further, in the device disclosed in Patent Literature 1, a cycle for executing a rich-spike operation is set that is common to the respective NOx catalysts based on the NOx storage capacity of each NOx catalyst. Therefore, a rich-spike operation can be started before NOx of an amount that exceeds the NOx storage capacity of the relevant NOx catalyst has been introduced into the NOx catalyst. Further, according to the device disclosed in Patent Literature 1, rich time periods are set based on the NOx storage capacity of the respective NOx catalysts, and furthermore, after the start of rich-spike operations, the air-fuel ratio of a NOx catalyst for which the rich time period ended earlier is controlled so as to be in the vicinity of the stoichiometric ratio until the rich time period of the other NOx catalyst ends. By controlling the air-fuel ratio so as to be in the vicinity of the stoichiometric ratio, storage of new NOx in the NOx catalyst can be suppressed. Accordingly, it is possible to prevent the aforementioned cycle for executing a rich-spike operation from being shortened by the storage of new NOx.

### CITATION LIST

### Patent Literature

[Patent Literature 1] Japanese Patent Laid-Open No. 2003-343314

[Patent Literature 2] Japanese Patent Laid-Open No. 2006-009702

[Patent Literature 3] Japanese Patent Laid-Open No. 2001-050041

[Patent Literature 4] Japanese Patent Laid-Open No. 2000-213340

[Patent Literature 5] Japanese Patent Laid-Open No. 2004-052641

### SUMMARY OF INVENTION

### Technical Problem

However, when an air-fuel ratio is controlled so as to be in the vicinity of the stoichiometric ratio after the end of a rich time period, there is the possibility that fuel consumption will deteriorate in comparison to a case where the air-fuel ratio is returned to a ratio for lean-burn operation immediately after the end of the rich time period. Accordingly, from the viewpoint of fuel consumption, there is still room for improvement in the device disclosed in Patent Literature 1.

The present invention has been conceived in view of the above described problem. That is, an object of the present invention is to suppress a deterioration in fuel consumption when simultaneously executing rich-spike operations for a plurality of cylinder groups.

### Solution to Problem

To solve the above problem, a first aspect of the present invention is a control device for an internal combustion engine including exhaust passages that are independently connected to each cylinder group of an internal combustion engine having a plurality of cylinder groups, and NOx catalysts that are provided in each of the exhaust passages, store NOx contained in exhaust gas during lean-burn operation by the internal combustion engine, and reduce and purify stored NOx during rich-burn operation by the internal combustion engine, the control device including: control means configured so as to simultaneously set air-fuel ratios of the cylinder groups to a rich side relative to a stoichiometric ratio and to calculate amounts of reducing agents to be introduced into the respective NOx catalysts when starting rich-spike operations, and to make termination timings of the rich-spike operations match between the cylinder groups by increasing a NOx reduction rate of a NOx catalyst for which a larger reducing agent amount is calculated relative to a NOx reduction rate of a NOx catalyst for which a smaller reducing agent amount is calculated when executing the rich-spike operations.

A second aspect of the present invention is the control device for an internal combustion engine according to the first aspect, wherein the control means is configured so as to set an air-fuel ratio of a cylinder group that is connected to a NOx catalyst for which a larger reducing agent amount is calculated further to a rich side than an air-fuel ratio of a cylinder group that is connected to a NOx catalyst for which a smaller reducing agent amount is calculated.

A third aspect of the present invention is the control device for an internal combustion engine according to the first aspect, wherein:
a port injector and an in-cylinder injector that are configured so that respective injection ratios of the port injector and the in-cylinder injector with respect to a total fuel amount can be controlled are provided in each cylinder of the internal combustion engine; and
the control means is configured so that an injection ratio of in-cylinder injectors of a cylinder group that is connected to a NOx catalyst for which a larger reducing agent amount is calculated is higher than an injection ratio of in-cylinder injectors of a cylinder group that is connected to a NOx catalyst for which a smaller reducing agent amount is calculated.

A fourth aspect of the present invention is the control device for an internal combustion engine according to the first aspect, wherein:
the NOx catalysts are configured so that bed temperatures of the NOx catalysts can each be independently controlled;
and the control means is configured so as to increase a bed temperature of a NOx catalyst for which a larger reducing agent amount is calculated in comparison to a bed temperature of a NOx catalyst for which a smaller reducing agent amount is calculated.

A fifth aspect of the present invention is the control device for an internal combustion engine according to any one of the first to fourth aspects, wherein:
concentration detection means for detecting a concentration of a product of a NOx reduction reaction by the NOx catalysts are provided downstream of the NOx catalysts, respectively; and
the control means is configured to compare a NOx catalyst performance that represent at least one of a NOx storage capacity and a NOx reduction capability of a NOx catalyst between the NOx catalysts based on a concentration of the product that is detected during execution of the rich-spike operations in which the NOx reduction rate in the NOx catalyst for which the larger reducing agent amount is calculated is increased relative to the NOx reduction rate in the NOx catalyst for which the smaller reducing agent amount is calculated, and in a case where performances of the respective NOx catalysts are equal, to prohibit independent control of NOx reduction rates of the NOx catalysts and uniformly control the cylinder groups a next time that the rich-spike operations are executed.

### Advantageous Effects of Invention

According to the first aspect of the present invention, the termination timings of rich-spike operations that were started simultaneously can be matched between cylinder groups. Accordingly, a deterioration in fuel consumption when simultaneously executing rich-spike operations for a plurality of cylinder groups can be suppressed.

According to the second aspect of the present invention, the air-fuel ratio of a cylinder group that is connected to a NOx catalyst for which a larger reducing agent amount is calculated can be set further to the rich side than an air-fuel ratio of a cylinder group that is connected to a NOx catalyst for which a smaller reducing agent amount is calculated. In a case where an air-fuel ratio is on a rich side relative to the stoichiometric ratio, the further to the rich side that the air-fuel ratio is set, the greater the amount of reducing agents that can be discharged from the internal combustion engine. The reduction rate of NOx in a NOx catalyst increases as the reducing agent amount is increased, and decreases as the reducing agent amount is decreased. Therefore, according to the second aspect, the termination timings of rich-spike operations can be matched between cylinder groups.

According to the third aspect of the present invention, an injection ratio of in-cylinder injectors of a cylinder group connected to a NOx catalyst for which a larger reducing agent amount is calculated can be set to a higher value than an injection ratio of in-cylinder injectors of a cylinder group connected to a NOx catalyst for which a smaller reducing agent amount is calculated. The higher the value that is set for the injection ratio of the in-cylinder injectors, the greater the amount of reducing agents that can be discharged from the internal combustion engine. Further, the reduction rate of NOx in a NOx catalyst increases as the reducing agent amount is increased, and decreases as the reducing agent amount is decreased. Therefore, according to the third aspect, the termination timings of rich-spike operations can be matched between cylinder groups.

According to the fourth aspect of the present invention, a bed temperature of a NOx catalyst for which a larger reducing agent amount is calculated can be set to a higher value than a bed temperature of a NOx catalyst for which a smaller reducing agent amount is calculated. A NOx reduction reaction in a NOx catalyst proceeds within an appropriate bed temperature range. The NOx reduction rate in the bed temperature range increases as the bed temperature increases, and decreases as the bed temperature decreases. Therefore, according to the fourth aspect, the termination timings of rich-spike operations can be matched between cylinder groups.

According to the fifth aspect of the present invention, in a case where the performances of the respective NOx catalysts are equal, the next time that rich-spike operations are executed, independent control of the NOx reduction rates in the NOx catalysts can be prohibited and all the cylinder groups can be uniformly controlled. Uniformly controlling all of the cylinder groups makes it possible to simplify the control of the NOx reduction rates. That is, according to the fifth aspect, a control load generated by executing control of the NOx reduction rates can be kept to the minimum.

### BRIEF DESCRIPTION OF DRAWINGS

FIG. 1 is a view that schematically illustrates the system configuration of Embodiment 1.

FIG. 2 is a view for describing a problem relating to the termination timings of the rich-spike operations.

FIG. 3 is a view for describing a problem relating to the termination timings of the rich-spike operations.

FIG. 4 is a view that illustrates an example of the execution of rich-spike operations

FIG. 5 is a flowchart that illustrates a routine for performing rich-spike operations that is executed by the ECU in Embodiment 1.

FIG. 6 is a view that schematically illustrates the system configuration of Embodiment 2.

FIG. 7 is a flowchart that illustrates a routine for performing rich-spike operations that is executed by the ECU in Embodiment 2.

FIG. 8 is a view that schematically illustrates the system configuration of Embodiment 3.

FIG. 9 is a flowchart that illustrates a routine for performing rich-spike operations that is executed by the ECU in Embodiment 3.

FIG. 10 is a view that schematically illustrates the system configuration of Embodiment 4.

### DESCRIPTION OF EMBODIMENTS

### Embodiment 1

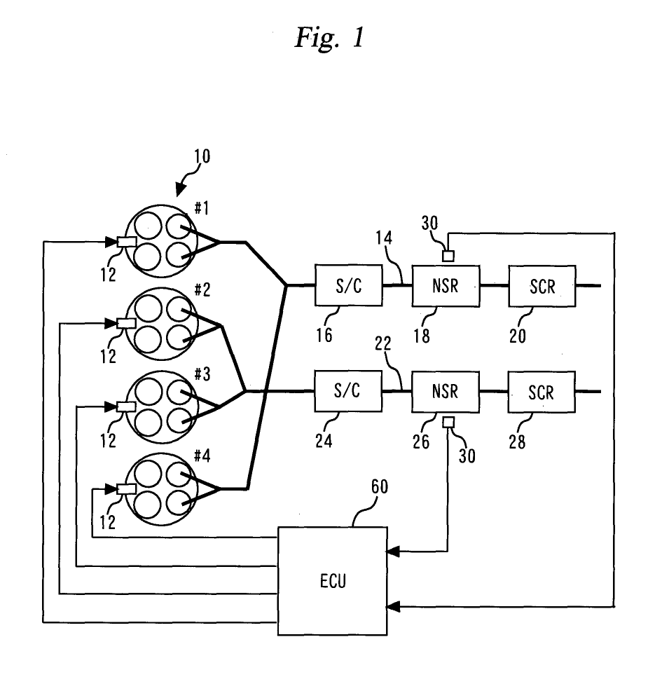

First, Embodiment 1 of the present invention will be described referring to FIG. 1 to FIG. 5.

### [Description of System Configuration]

FIG. 1 is a view that schematically illustrates the system configuration of Embodiment 1. As shown in FIG. 1, the system of the present embodiment includes an internal combustion engine 10 that is mounted in a vehicle or the like. An in-cylinder injector 12 that injects fuel directly into the relevant cylinder is disposed in each cylinder of the internal combustion engine 10. A configuration may also be adopted in which port injectors that inject fuel into intake ports (not illustrated in the drawing) are provided instead of the in-cylinder injectors 12.

The internal combustion engine 10 includes two cylinder groups (banks), and two exhaust passages that correspond to the two cylinder groups. More specifically, the internal combustion engine 10 includes an exhaust passage 14 that communicates with a first and a fourth cylinder, and an exhaust passage 22 that communicates with a second and a third cylinder. Note that, in the following description, the cylinder group having the first and fourth cylinder is referred to as “bank 1” and the cylinder group having the second and third cylinder is referred to as “bank 2”.

A three-way catalyst (S/C) 16, an NSR catalyst (NOx storage reduction catalyst) 18 and an SCR catalyst (selective catalytic reduction catalyst) 20 are arranged in this order in the exhaust passage 14. Likewise, a three-way catalyst 24, an NSR catalyst 26 and an SCR catalyst 28 are arranged in this order in the exhaust passage 22.

The internal combustion engine 10 is configured to be capable of operating in a wide air-fuel ratio range from a lean air-fuel ratio to a rich air-fuel ratio. The internal combustion engine 10 tends to emit HC and CO during operation under a rich air-fuel ratio, and tends to emit NOx during operation under a lean air-fuel ratio. Under a lean atmosphere, the three-way catalysts 16 and 24 reduce NOx while adsorbing oxygen to thereby purify the NOx to N₂. On the other hand, under a rich atmosphere, the three-way catalysts 16 and 24 oxidize HC and CO while releasing oxygen to thereby purify the HC and CO to H₂O and CO₂.

Under a lean atmosphere the NSR catalysts 18 and 26 store the NOx contained in exhaust gas. Under a rich atmosphere the NSR catalysts 18 and 26 release the stored NOx. The NOx that has been released is reduced by reducing agents (HC, CO, H₂). At such time, in the NSR catalysts 18 and 26, the N₂ generated by reducing the NOx undergoes a further reaction with H₂ to generate ammonia (NH₃).

The SCR catalysts 20 and 28 have a function of storing the NH₃ that was generated under a rich atmosphere, and selectively reducing NOx contained in exhaust gases under a lean atmosphere by using the NH₃ as a reducing agent. The occurrence of a situation in which NH₃ or NOx that was blown through to the downstream side of the NSR catalysts 18 and 26 is released into the atmosphere can be avoided by means of the SCR catalysts 20 and 28.

The system of the present embodiment also includes an ECU (electronic control unit) 60. In addition to a temperature sensor 30 that detects the temperature (bed temperature) of the NSR catalysts 18 and 26, various sensors (for example, a crank angle sensor that detects engine speed, an air flow meter that detects an intake air amount, a throttle sensor that detects the degree of opening of a throttle valve, and a temperature sensor that detects the engine water temperature) that are required for control of the internal combustion engine 10 are electrically connected to an input side of the ECU 60. On the other hand, various actuators, such as the in-cylinder injectors 12 of the first to fourth cylinders are electrically connected to an output side of the ECU 60. The ECU 60 executes various kinds of control relating to operation of the internal combustion engine 10 by executing a predetermined program based on information that is input from the various sensors, and actuating various actuators and the like.

### [Rich-Spike Operations For Bank 1 and Bank 2]

In the present embodiment, from the viewpoint of reducing fuel consumption, lean-burn operation is performed in which a target air-fuel ratio of the internal combustion engine 10 is set to a value (for example, A/F=25.0) on the lean side relative to the stoichiometric ratio. NOx that passed through the three-way catalyst 16 during lean-burn operation flows into the NSR catalyst 18 and is stored. Likewise, NOx that passed through the three-way catalyst 24 is stored in the NSR catalyst 26. In this case, if the amount of NOx stored in an NSR catalyst (hereunder, referred to as “NOx storage amount”) exceeds an allowable storage value of the relevant NSR catalyst, NOx contained in exhaust gas will also pass through the NSR catalyst and will be discharged into the atmosphere. Consequently, in the present embodiment, the target air-fuel ratios for the bank 1 and the bank 2 are temporarily set to a value on the rich side relative to the stoichiometric ratio to execute rich-spike operations that release NOx that has been stored in the NSR catalysts 18 and 26.

By executing a rich-spike operation, exhaust gas including reducing agents (HC, CO, H₂) can be introduced into the NSR catalysts 18 and 26 and consequently NOx can be reduced. The NOx storage capacity of the NSR catalysts 18 and 26 can thereby be restored. However, individual differences exist with respect to the NOx storage capacity. Consequently, a timing at which the NOx storage amount of the NSR catalyst 18 exceeds an allowable storage amount thereof and a timing at which the NOx storage amount of the NSR catalyst 26 exceeds an allowable storage amount thereof do not necessarily coincide. Therefore, in the present embodiment, at a timing at which the NOx storage amount of one of the NSR catalysts has reached the allowable storage amount thereof, rich-spike operations are started simultaneously for both the bank 1 and the bank 2. The target air-fuel ratios of the bank 1 and the bank 2 after the rich-spike operation starts are set to a fixed value (for example, A/F=12.5).

### [Characteristic Control in Embodiment 1]

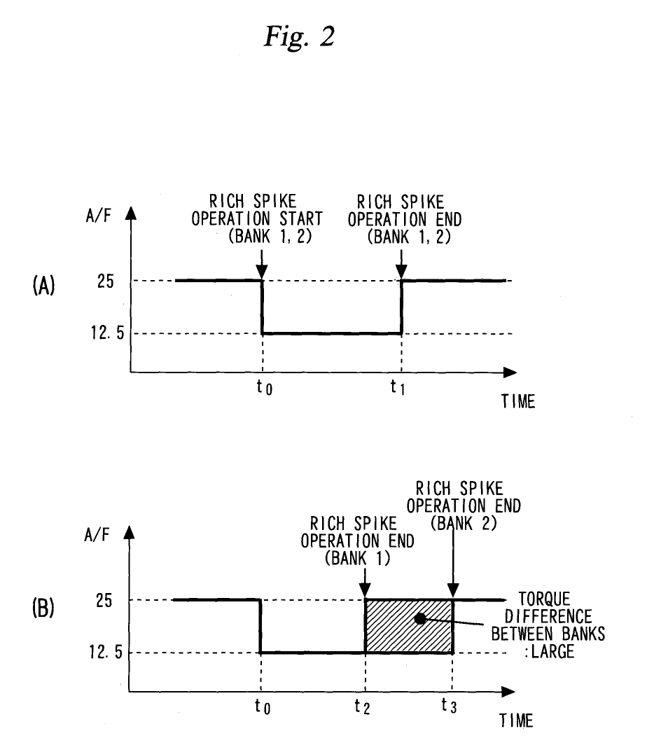

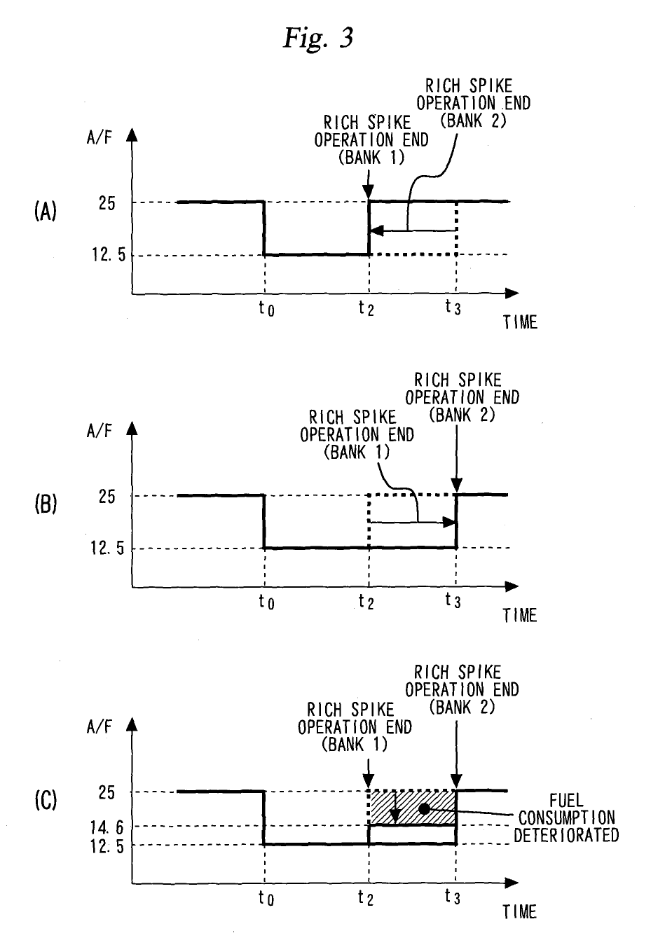

In the present embodiment, the rich-spike operations are terminated by returning the target air-fuel ratios of the bank 1 and the bank 2 from the aforementioned value to a value on the lean side (for example, A/F=25.0). The termination timings of the rich-spike operations will now be described referring to FIG. 2 and FIG. 3. FIG. 2 and FIG. 3 are views for describing a problem relating to the termination timings of the rich-spike operations. Note that, in FIG. 2 and FIG. 3, rich-spike operations with respect to both the bank 1 and the bank 2 are started at a time t₀. Further, in the description of these drawings, the term “NOx storage amount” of the NSR catalysts 18 and 26 refers to a value at the time t₀.

FIG. 2(A) illustrates a case where the NOx storage amount of the NSR catalyst 18 and the NOx storage amount of the NSR catalyst 26 are equal. In this case, by setting the target air-fuel ratios of the bank 1 and the bank 2 to the same value (A/F=12.5), the rich-spike operations for these banks can be simultaneously terminated at a time t₁. In contrast, FIG. 2(B) illustrates a case where the NOx storage amount of the NSR catalyst 26 is greater than the NOx storage amount of the NSR catalyst 18. In this case, if the target air-fuel ratios of the bank 1 and the bank 2 are set to the same value (A/F=12.5), although the rich-spike operation for the bank 1 will terminate at a time t₂, the rich-spike operation for the bank 2 will be continued until a time t₃.

The problem described above using FIGS. 2(A) and (B) is due to individual differences in the NOx storage capacities. This problem can also be caused by individual differences in the NOx reduction capabilities of the NSR catalysts. The reason is that, if there are individual differences in the NOx reduction capabilities, even if the NOx storage amount of the NSR catalyst 18 and the NOx storage capacities of the NSR catalyst 26 are the same, a deviation will arise between the termination timings of the rich-spike operations. The NOx reduction capability varies depending on the temperature (bed temperature) of the NSR catalyst and the degree of deterioration of the NSR catalyst.

In FIG. 2(B), the target air-fuel ratio of the bank 1 from the time t₂ onwards is returned to the value thereof (A/F=25.0) at the time before the rich-spike operation started. Consequently, as shown in FIG. 2(B), there is a problem that a torque difference between the bank 1 and the bank 2 from the time t₂ until the time t₃ is large, and the drivability deteriorates. For this reason, it is preferable to make the termination timings of the rich-spike operations the same for the bank 1 and the bank 2.

The termination timings of the rich-spike operations for the two banks can be made the same by changing the termination timing of a rich-spike operation for one of the banks. FIG. 3(A) illustrates a case where the termination timing of the rich-spike operation for the bank 2 is advanced to the time t₂. However, in this case, the amount of stored NOx released from the NSR catalyst 26 will be insufficient. In such a case, the NOx storage amount of the NSR catalyst 26 will reach the allowable storage amount again, and the fuel consumption will deteriorate because the frequency of executing the rich-spike operations will increase. FIG. 3(B) illustrates a case where the termination timing for the bank 1 is extended until the time t₃. However, since this case represents an excessive rich-spike operation for the bank 1, not only does the fuel consumption deteriorate, but the problem also arises that the amount of discharged HC increases.

After the end of a rich-spike operation with respect to one of the banks, it is also possible to gradually return the target air-fuel ratio of the relevant bank to a value on the lean side. FIG. 3(C) illustrates a case where the termination timing of bank 1 is set to the time t₂ and, furthermore, from the time t₂ to the time t₃, the target air-fuel ratio of the bank 1 is set to the stoichiometric ratio (A/F=14.6). However, in this case, although the problem concerning a deterioration in the fuel consumption is improved in comparison to the case illustrated FIG. 3(B), the problem concerning the fuel consumption is still not completely solved.

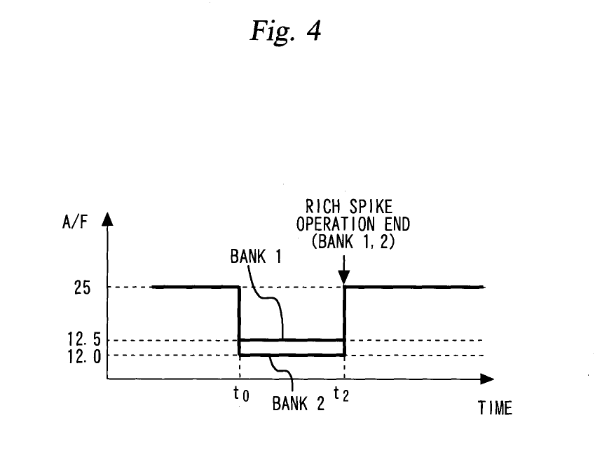

In view of the above problems, in the present embodiment the amount of reducing agents to be introduced to the respective NSR catalysts during rich-spike operations are calculated when starting the rich-spike operations. The reducing agent amounts are calculated based on the NOx storage capacity and NOx reduction capability of the respective NSR catalysts. Further, in the present embodiment, during rich-spike operations that are executed immediately after the reducing agent amounts are calculated, the target air-fuel ratios for the respective banks are controlled based on the calculated reducing agent amounts, and thus the termination timings of the rich-spike operations for the respective banks are made the same. FIG. 4 is a view that illustrates an example of the execution of rich-spike operations. FIG. 4 illustrates a case where the NOx storage capacity of the NSR catalyst 26 is greater than the NOx storage capacity of the NSR catalyst 18. That is, similarly to FIG. 2(B), FIG. 4 illustrates a case where the NOx storage amount of the NSR catalyst 26 is greater than the NOx storage amount of the NSR catalyst 18. Note that, in the description of FIG. 4, it is assumed that the NOx reduction capabilities of the NSR catalysts 18 and 26 are equal.

As shown in FIG. 4, in the present embodiment the target air-fuel ratio of the bank 1 is set to a normal value (A/F=12.5). In contrast, the target air-fuel ratio of the bank 2 is set to a value on the rich side (A/F=12.0) relative to the aforementioned normal value. By this means, the amount of reducing agents (HC, CO, H₂) contained in exhaust gas from the bank 2 can be increased, and hence the NOx reduction rate in the NSR catalyst 26 can be increased relative to the NOx reduction rate in the NSR catalyst 18. Accordingly, the termination timing of the rich-spike operation with respect to the bank 2 can be made to coincide with the termination timing (time t₂) of the rich-spike operation with respect to the bank 1. Hence, the occurrence of a problem that is caused by a deviation between the termination timings of the rich-spike operations can be avoided.

### [Specific Processing]

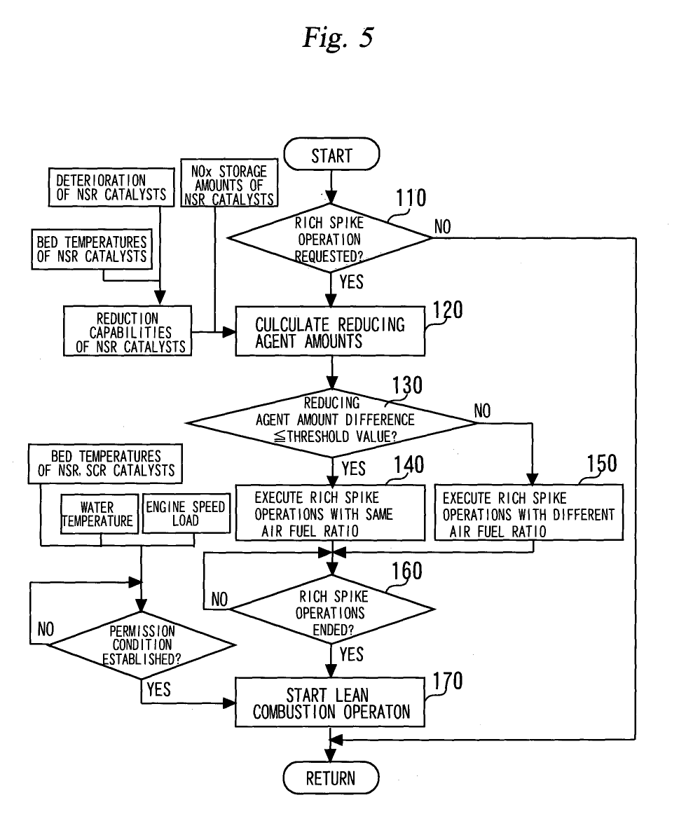

Next, specific processing for realizing the above described function will be described with reference to FIG. 5. FIG. 5 is a flowchart that illustrates a routine for performing rich-spike operations that is executed by the ECU 60 in Embodiment 1. Note that it is assumed that the routine illustrated in FIG. 5 is repeatedly executed at predetermined intervals.

In the routine illustrated in FIG. 5, the ECU 60 determines whether or not there is a request to perform a rich-spike operation (step 110). The ECU 60 determines that there is a request to perform a rich-spike operation if the NOx storage amount of either of the NSR catalysts 18 and 26 reached the allowable storage amount thereof. Note that values that are previously set and stored in the ECU 60 are used as the allowable storage amounts of the respective NSR catalysts. If the ECU 60 determines that there is not a request to perform a rich-spike operation, the present routine is ended.

In step 110, if it is determined that there is a request to perform a rich-spike operation, the ECU 60 calculates the amount of reducing agents (HC, CO, H₂) to be introduced into the respective NSR catalysts (step 120). More specifically, the NOx reduction capability of the respective NSR catalysts at the current time point is calculated. The NOx reduction capability is calculated based on a model or the like that is constructed by taking the bed temperature and degree of deterioration of the respective NSR catalysts as variables and is stored inside the ECU 60. Simultaneously, the NOx storage amount of the respective NSR catalysts at the current time point is calculated. In this case, the NOx storage amount at the current time of the NSR catalyst of the bank for which there is a request to perform a rich-spike operation is equal to the allowable storage amount. Therefore, in this case the NOx storage amount is calculated with respect to the NSR catalyst that is connected to the bank that is different to the bank with respect to which there is a request to perform a rich-spike operation. Further, the amounts of reducing agent to be introduced into the respective NSR catalysts are calculated based on the respective NOx reduction capabilities and NOx storage amounts that were calculated. Note that the bed temperatures of the respective NSR catalysts are calculated based on output values of the respective temperature sensors 30. Further, the degrees of deterioration of the respective NSR catalysts are calculated based on, for example, a model that is constructed by taking into consideration the operation history of the internal combustion engine 10, the past history of rich-spike operations with respect to the respective banks and the like, and is stored inside the ECU 60.

Next, the ECU 60 determines whether or not a difference between the reducing agent amounts to be introduced into the respective NSR catalysts is small (step 130). More specifically, the ECU 60 determines whether or not a difference between the reducing agent amounts calculated in step 120 is less than or equal to a threshold value. A value that is previously set and stored in the ECU 60 is used as the threshold value. If the ECU 60 determines that the difference is less than or equal to the threshold value, it can be determined that even if the target air-fuel ratios of the bank 1 and the bank 2 are set to the same value, the rich-spike operations for these banks can be terminated at the same time. Consequently, in this case, the target air-fuel ratios of the bank 1 and the bank 2 are set to the normal value (A/F=12.5) (step 140).

If the ECU 60 determines in step 130 that the reducing agent amount difference exceeds the threshold value, the target air-fuel ratios of the bank 1 and the bank 2 are set to different values. More specifically, the target air-fuel ratio of the bank for which the reducing agent amount calculated in step 120 is smaller is set to the normal value (A/F=12.5), and the target air-fuel ratio of the bank for which the reducing agent amount calculated in step 120 is larger is set to a lower value (A/F=12.0) than the normal value (step 150). By this means, it is possible to terminate the rich-spike operations for the bank 1 and the bank 2 at the same time. The NOx storage amounts of the respective NSR catalysts decrease during the rich-spike operations, and match at the termination timing of the rich-spike operations. The NOx storage amounts at the time that the rich-spike operations terminate can be set to a fixed value (for example, zero). Note that a configuration may also be adopted in which the NOx storage amounts at the time that the rich-spike operations terminate are determined based on a model or the like that has been separately stored in advance the ECU 60.

After the processing in step 150, the ECU 60 determines whether or not the rich-spike operations have ended (step 160). Upon determining that the rich-spike operations ended in step 160, the ECU 60 starts lean-burn operation (step 170). When starting the lean-burn operation, the ECU 60 checks that conditions for permitting lean-burn operation are established. Examples of such conditions for permitting lean-burn operation include that the bed temperatures of the NSR catalysts 18 and 26 and the SCR catalysts 20 and 28 are within a fixed range, that the engine water temperature is equal to or greater than a predetermined value, and that the operating state of the internal combustion engine 10 is steady based on the engine speed and the load.

Thus, according to the routine illustrated in FIG. 5, when there is a request to perform a rich-spike operation with respect to one of the NSR catalysts, the reducing agent amounts to be introduced into the respective NSR catalysts are calculated, and the target air-fuel ratios for the bank 1 and the bank 2 can be set in accordance with a difference between the reducing agent amounts. Accordingly, even in a case where the NOx storage capacities or the NOx reduction capabilities of the NSR catalysts 18 and 26 are different to each other, rich-spike operations for the bank 1 and the bank 2 can be terminated at the same time. Hence, the occurrence of a problem that is caused by a deviation in the termination timings of the rich-spike operations can be avoided.

Although in the above described Embodiment 1 a configuration is adopted in which the internal combustion engine 10 includes two banks and two NSR catalysts that correspond to the two banks, a configuration may also be adopted in which the internal combustion engine 10 includes three or more banks as well as NSR catalysts that correspond to the three or more banks. In that case also, the rich-spike operations for all the banks can be terminated at the same time by calculating reducing agent amounts to be introduced into the respective NSR catalysts, and setting the target air-fuel ratios of the respective banks in accordance with differences between the reducing agent amounts. Note that, the present modification can also be similarly applied to Embodiments 2 and 3 that are described later.

Further, in the above described Embodiment 1, the first and fourth cylinder of the internal combustion engine 10 are adopted as the bank 1 and the second and third cylinder are adopted as the bank 2. However, various modifications are possible with respect to the setting of the banks 1 and 2 in accordance with the number of cylinders and the cylinder arrangement of the internal combustion engine 10. For example, in a case where the internal combustion engine 10 is a V-type engine including two cylinder groups and NSR catalysts that correspond to the cylinder groups, one of the cylinder groups may be taken as the bank 1 and the other cylinder group may be taken as the bank 2.

Further, in the above described Embodiment 1, reducing agent amounts to be introduced into the respective NSR catalysts during rich-spike operations are calculated based on the NOx storage capacities and NOx reduction capabilities of the respective NSR catalysts. However, the reducing agent amounts may be calculated based on only the NOx storage capacities of the respective NSR catalysts. If it is assumed that the bed temperature and the degree of deterioration are the same in both of the NSR catalysts, the reducing agent amounts can be calculated based on only the respective NOx storage amounts.

Although in the above described Embodiment 1 the respective temperatures of the NSR catalysts 18 and 26 are detected by the temperature sensor 30, these temperatures may also be obtained by estimation.

Note that, in the above described Embodiment 1, the NSR catalysts 18 and 26 correspond to “NOx catalysts” in the above described first aspect of the present invention.

Further, “control means” in the above described first aspect of the present invention is realized by the ECU 60 executing the processing in steps 110 to 160 in FIG. 5.

### Embodiment 2

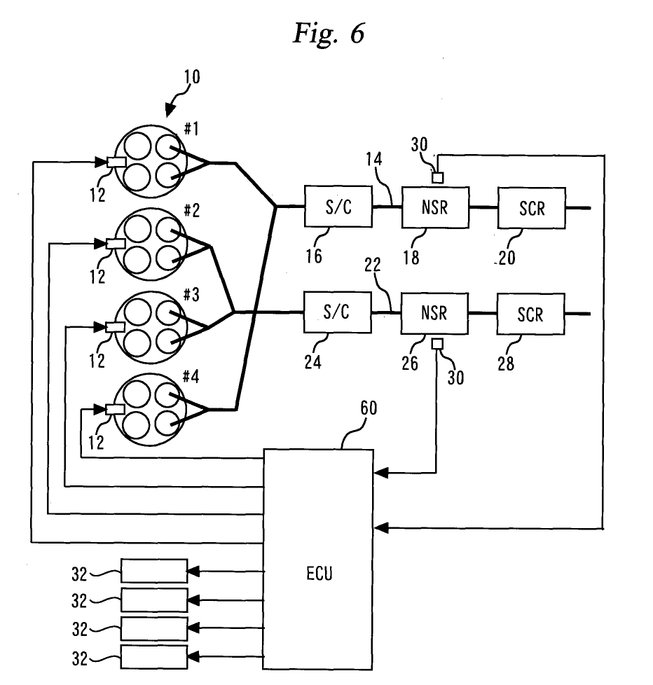

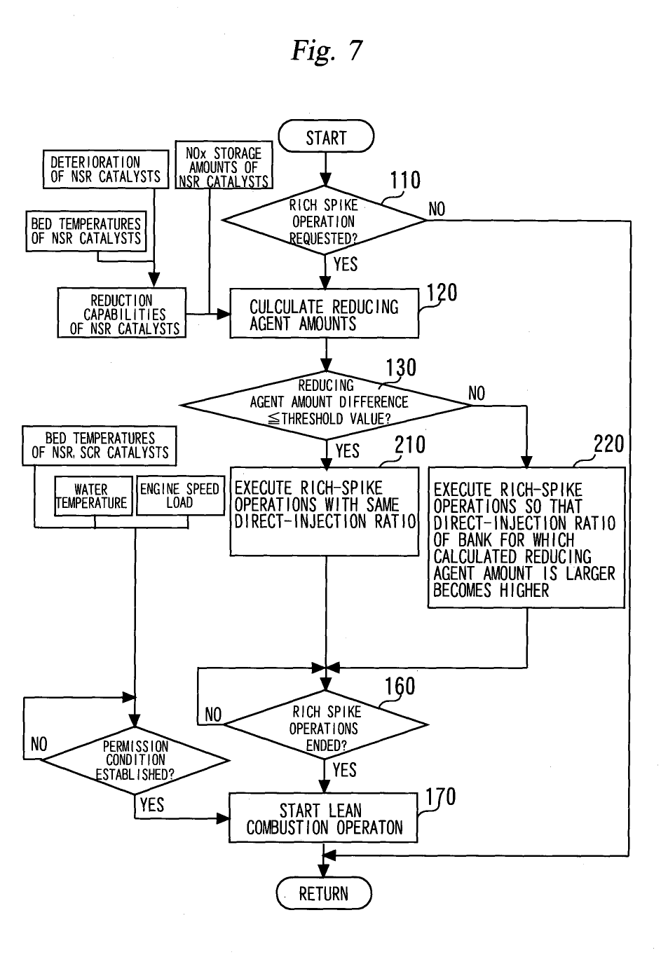

Next, Embodiment 2 of the present invention will be described with reference to FIG. 6 and FIG. 7. Note that, in the description of the present embodiment, a description regarding parts that are common with Embodiment 1 is omitted or abbreviated, and the description focuses on parts that are different to Embodiment 1

### [Description of System Configuration]

FIG. 6 is a view that schematically illustrates the system configuration of Embodiment 2. As shown in FIG. 6, in addition to the in-cylinder injectors 12 that inject fuel directly into the cylinders, the system of the present embodiment includes port injectors 32 for each cylinder. The port injectors 32 inject fuel into intake ports (not illustrated in the drawing) of the respective cylinders. The port injectors 32 are connected to an output side of the ECU 60. The ECU 60 is configured so as to set an injection ratio (hereunder, referred to as “direct-injection ratio”) of the in-cylinder injectors 12 with respect to the total fuel amount.

### [Characteristic Control of Embodiment 2]

In the above described Embodiment 1, reducing agent amounts to be introduced into the respective NSR catalysts during rich-spike operations are calculated, and if a difference between these reducing agent amounts exceeds a threshold value, the target air-fuel ratios of the bank 1 and the bank 2 are set to different values. In the present embodiment, in a case where the reducing agent amount difference exceeds the threshold value, a similar function as in Embodiment 1 is realized by setting a direct-injection ratio for each bank, and not by setting the target air-fuel ratios of the bank 1 and the bank 2 to different values. Note that, in the present embodiment, the target air-fuel ratios of the bank 1 and the bank 2 during the rich-spike operations are set to the same value.

Fuel injected from each port injector mixes with intake air to form a homogeneous air-fuel mixture inside the relevant cylinder. Consequently, the amount of reducing agents (HC, CO, H₂) contained in exhaust gas is less when fuel injected from a port injector is combusted in comparison to when fuel injected from an in-cylinder injector is combusted. Hence, the reducing agent amount contained in exhaust gas from the bank 1 and the reducing agent amount contained in exhaust gas from the bank 2 can be varied by setting the direct-injection ratios of the bank 1 and the bank 2 to differing values.

The characteristic control of the present embodiment will now be described taking as an example a case where the NOx storage amount of the NSR catalyst 26 is greater than the NOx storage amount of the NSR catalyst 18. In this case, the direct-injection ratios of the respective banks are set so that the direct-injection ratio of the bank 2 is higher than the direct-injection ratio of the bank 1. By this means, since the amount of reducing agents (HC, CO, H₂) contained in exhaust gas from the bank 2 can be increased, the NOx reduction rate in the NSR catalyst 26 can be made faster than the NOx reduction rate in the NSR catalyst 18.

### [Specific Processing]

FIG. 7 is a flowchart illustrating a routine for performing rich-spike operations that is executed by the ECU 60 in Embodiment 2. In the routine illustrated in FIG. 7, the ECU 60 executes basically the same processing as that in the routine illustrated in FIG. 5. However, the routine illustrated in FIG. 7 differs from the routine illustrated in FIG. 5 in the respect that although in steps 130 and 140 in FIG. 5 the ECU 60 controls “target air-fuel ratios” of the bank 1 and the bank 2, in steps 210 and 220 in FIG. 7 the ECU 60 controls “direct-injection ratios” of the bank 1 and the bank 2. More specifically, in step 210, the direct-injection ratios of the bank 1 and the bank 2 are set to the same value. Further, in step 220, the value of the direct-injection ratio of the bank for which a larger reducing agent amount was calculated in step 120 is set to a higher value than the value of the direct-injection ratio of the bank for which the smaller reducing agent amount was calculated in step 120.

Thus, according to Embodiment 2, rich-spike operations with respect to the bank 1 and the bank 2 can be terminated at the same time. Hence, the same effects as in the above described Embodiment 1 can be obtained.

In this connection, although a direct-injection ratio is set for each bank in the above described Embodiment 2, a configuration may also be adopted in which an injection ratio of the port injectors 32 with respect to the total injection amount (port-injection ratio) is set for each bank instead of a direct-injection ratio.

### Embodiment 3

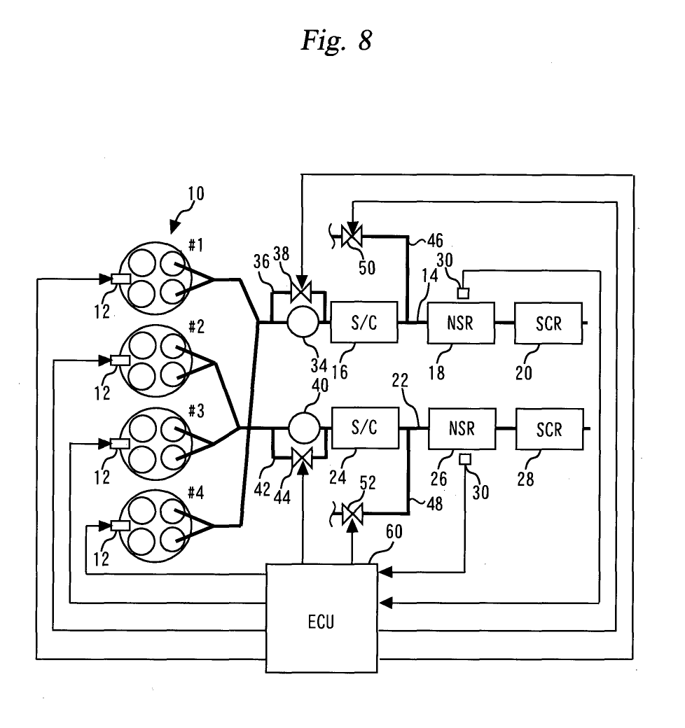

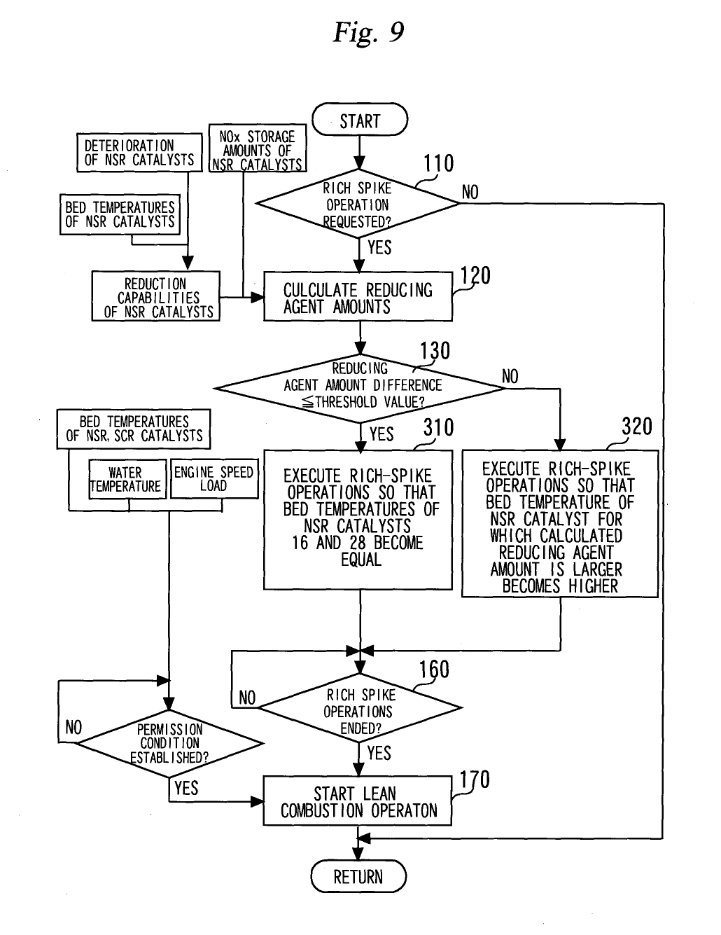

Next, Embodiment 3 of the present invention will be described with reference to FIG. 8 and FIG. 9. Note that, in the description of the present embodiment, a description regarding parts that are common with Embodiment 1 is omitted or abbreviated, and the description focuses on parts that are different to Embodiment 1

### [Description of System Configuration]

FIG. 8 is a view that schematically illustrates the system configuration of Embodiment 3. As shown in FIG. 8, the system of the present embodiment includes a turbine 34 of a turbocharger that is provided in the exhaust passage 14, an exhaust gas bypass passage 36 that bypasses the turbine 34, and a WGV (waste gate valve) 38 that is provided in the exhaust gas bypass passage 36. The system of the present embodiment also includes a turbine 40 of a turbocharger that is provided in the exhaust passage 22, an exhaust gas bypass passage 42 that bypasses the turbine 40, and a WGV 44 provided in the exhaust gas bypass passage 42.

The system of the present embodiment further includes EGR passages 46 and 48 that recirculate exhaust gas to an intake passage (not illustrated in the drawings) from the exhaust passages 14 and 22, and EGR valves 50 and 52 provided in the EGR passages 46 and 48. The WGVs 38 and 44 and the EGR valves 50 and 52 are connected to the output side of the ECU 60.

### [Characteristic Control of Embodiment 3]

In the foregoing Embodiment 1, reducing agent amounts to be introduced into the respective NSR catalysts during rich-spike operations are calculated, and if a difference between these reducing agent amounts exceeds a threshold value, the target air-fuel ratios of the bank 1 and the bank 2 are set to different values. In the present embodiment, in a case where the reducing agent amount difference exceeds the threshold value, a similar function as in Embodiment 1 is realized by controlling the bed temperatures of the NSR catalysts 18 and 26 during rich-spike operations to different values, and not by setting the target air-fuel ratios of the bank 1 and the bank 2 to different values. Note that, in the present embodiment, the target air-fuel ratios of the bank 1 and the bank 2 during the rich-spike operations are set to the same value. A NOx reduction reaction that proceeds on an NSR catalyst becomes increasingly active as the bed temperature of the NSR catalyst increases. Consequently, the NOx reduction rate in an NSR catalyst can be increased by increasing the bed temperature of the NSR catalyst within an appropriate range.

The characteristic control of the present embodiment will now be described taking as an example a case where the NOx storage amount of the NSR catalyst 26 is greater than the NOx storage amount of the NSR catalyst 18. In this case, the degree of opening of the WGV 44 is controlled so as to be greater than the degree of opening of the WGV 38. By this means, the amount of exhaust gas that bypasses the turbine 40 is made larger than the amount of exhaust gas that bypasses the turbine 34. Alternatively, the degree of opening of the EGR valve 52 is controlled so as to be less than the degree of opening of the EGR valve 50. By this means, the amount of exhaust gas introduced into the NSR catalyst 26 is made larger than the amount of exhaust gas introduced into the NSR catalyst 18. Alternatively, the fuel injection timing of the in-cylinder injectors 12 of the bank 2 is controlled to a retardation side relative to the fuel injection timing of the in-cylinder injectors 12 of the bank 1. By this means, an afterburning period of the bank 2 is lengthened relative to the bank 1.

According to the three kinds of control mentioned above, the bed temperature of the NSR catalyst 26 can be made a higher temperature than the bed temperature of the NSR catalyst 18. Accordingly, the NOx reduction rate in the NSR catalyst 26 can be increased relative to the NOx reduction rate in the NSR catalyst 18. Note that these controls may be executed independently or two or more of these controls may be executed concurrently.

### [Specific Processing]

FIG. 9 is a flowchart illustrating a routine for performing rich-spike operations that is executed by the ECU 60 in Embodiment 3. In the routine illustrated in FIG. 9, the ECU 60 executes basically the same processing as that in the routine illustrated in FIG. 5. However, the routine illustrated in FIG. 9 differs from the routine illustrated in FIG. 5 in the respect that although in steps 130 and 140 in FIG. 5 the ECU 60 controls “target air-fuel ratios” of the bank 1 and the bank 2, in steps 310 and 320 in FIG. 9 the ECU 60 controls “bed temperatures of the NSR catalysts 16 and 28”. More specifically, in step 310, rich-spike operations are executed so that the bed temperatures of the NSR catalysts 16 and 28 become equal to each other. Further, in step 320, rich-spike operations are executed so that the bed temperature of the NSR catalyst for which the larger reducing agent amount was calculated in step 120 becomes higher than the bed temperature of the NSR catalyst for which the smaller reducing agent amount was calculated in step 120.

Thus, according to Embodiment 3, rich-spike operations with respect to the bank 1 and the bank 2 can be terminated at the same time. Hence, the same effects as in the above described Embodiment 1 can be obtained. Further, according to the control of the WGVs or EGR valves described in the present embodiment, since control for the respective banks need not be performed, the control during execution of the rich-spike operations can be simplified.

In this connection, although in the above described embodiment the bed temperatures of the NSR catalysts 18 and 26 are controlled to different temperatures to each other by the aforementioned three types of control, the bed temperatures of the NSR catalysts 18 and 26 can also be controlled by other types of control. For example, control that varies the closing timings of the exhaust valves between the banks may be mentioned as another control. If the closing timing of an exhaust valve is advanced, burned gas trapped inside the cylinder is compressed and a pumping loss is generated. Since the generated pumping loss is converted into thermal energy of air that is drawn into the cylinder thereafter, the in-cylinder temperature at compression top dead center rises. As a result, exhaust loss increases and the exhaust gas temperature rises. Thus, the bed temperatures of the NSR catalysts 18 and 26 can also be controlled to different values to each other by control that varies the closing timings of the exhaust valves of the bank 1 and the bank 2.

### Embodiment 4

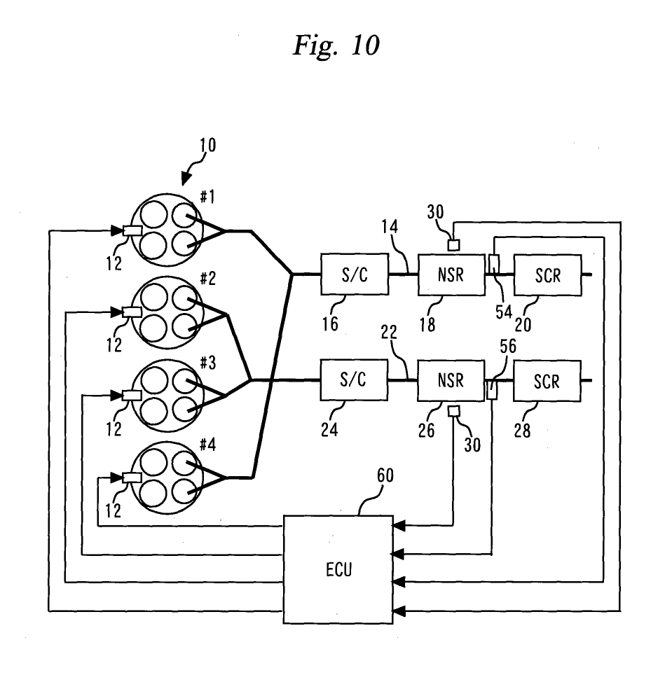

Next, Embodiment 4 of the present invention will be described with reference to FIG. 10. Note that, in the description of the present embodiment, a description regarding parts that are common with Embodiment 1 is omitted or abbreviated, and the description focuses on parts that are different to Embodiment 1

### [Description of System Configuration]

FIG. 10 is a view that schematically illustrates the system configuration of Embodiment 4. As shown in FIG. 10, the system of the present embodiment includes a NOx sensor 54 that is provided between the NSR catalyst 18 and the SCR catalyst 20, and a NOx sensor 56 that is provided between the NSR catalyst 26 and the SCR catalyst 28. The NOx sensors 54 and 56 are configured to be capable of also detecting an NH3 concentration contained in exhaust gas in addition to a NOx concentration in the exhaust gas.

### [Characteristic Control of Embodiment 4]

In the above described Embodiment 1, the reducing agent amounts to be introduced into the respective NSR catalysts during rich-spike operations are calculated, and target air-fuel ratios of the respective banks are set in accordance with a difference between the reducing agent amounts. However, the reducing agent amounts are estimated values of the NOx storage capacity or NOx reduction capability of the NSR catalysts 18 and 26, and are not necessarily accurate. Therefore, for example, in some cases the actual NOx storage capacities or NOx reduction capabilities of the NSR catalysts 18 and 26 can be regarded as being equal even though it was determined that the difference between the reducing agent amounts exceeds the threshold value.

Therefore, in the present embodiment, during the execution of rich-spike operations in which the NOx reduction rate in one of the NSR catalysts is increased relative to the NOx reduction rate in the other NSR catalyst, the actual NOx storage capacities or NOx reduction capabilities of the NSR catalysts 18 and 26 are estimated based on the behavior of the output values of the NOx sensors 54 and 56. As described above, under a rich atmosphere, NOx is reduced in the NSR catalysts 18 and 26 and N₂ is generated, and the N₂ then reacts with H₂ to generate NH₃. The generated NH₃ flows to the downstream side of the NSR catalysts 18 and 26 and is detected by the NOx sensors 54 and 56. Accordingly, it can be said that the behavior of the output values of the NOx sensors 54 and 56 during rich-spike operations has a high correlation with the actual NOx storage capacities or NOx reduction capabilities of the NSR catalysts 18 and 26.

In the present embodiment, whether or not the actual NOx storage capacities or NOx reduction capabilities of the NSR catalysts 18 and 26 are equal is determined by performing a comparison with the behavior of the output values of the NOx sensors 54 and 56. More specifically, the timings at which detection of NH₃ ends in the NOx sensors 54 and 56 (for example, a timing at which the output value of the relevant NOx sensor becomes equal to or less than a predetermined value) are compared. Further, if a difference between the aforementioned ending timings is equal to or greater than a predetermined time period, the ECU 60 determines that the actual NOx storage capacities or NOx reduction capabilities of the NSR catalysts 18 and 26 are equal. If it is determined that the actual NOx storage capacities or NOx reduction capabilities are equal, when executing the next rich-spike operations, independent control of the target air-fuel ratios of the bank 1 and the bank 2 is prohibited and the target air-fuel ratios are uniformly controlled. More specifically, rich-spike operations with respect to the bank 1 and the bank 2 are executed in accordance with the target air-fuel ratio of the bank with respect to which there is a request to perform a rich-spike operation.

On the other hand, in a case where it is determined that the actual NOx storage capacities or NOx reduction capabilities of the NSR catalysts 18 and 26 are not equal, similarly to the current rich-spike operations, the target air-fuel ratios for each bank are controlled in the next rich-spike operations also.

Thus, according to Embodiment 4, depending on a comparison with the behavior of the output values of the NOx sensors 54 and 56 during rich-spike operations, control of the target air-fuel ratios in the next rich-spike operations can be switched to uniform control. By switching to uniform control, the control during execution of the rich-spike operations can be simplified because it is not necessary to perform control for the respective banks.

Note that, in the above described Embodiment 4, the NOx sensors 54 and 56 correspond to “concentration detection means” in the above described fifth aspect of the present invention.

### REFERENCE SIGNS LIST

10 Internal combustion engine
12 in-cylinder injector
14, 22 exhaust passage
16, 24 three-way catalyst
18, 26 NSR catalyst
20, 28 SCR catalyst
32 port injector
54, 56 NOx sensor
60 ECU

1. A control device for an internal combustion engine including exhaust passages that are independently connected to each cylinder group of an internal combustion engine having a plurality of cylinder groups, and NOx catalysts that are provided in each of the exhaust passages, store NOx contained in exhaust gas during lean-burn operation by the internal combustion engine, and reduce and purify stored NOx during rich-burn operation by the internal combustion engine, the control device comprising:
control means configured so as to simultaneously set air-fuel ratios of the cylinder groups to a rich side relative to a stoichiometric ratio and to calculate amounts of reducing agents to be introduced into the respective NOx catalysts when starting rich-spike operations, and to make termination timings of the rich-spike operations match between the cylinder groups by increasing a NOx reduction rate of a NOx catalyst for which a larger reducing agent amount is calculated relative to a NOx reduction rate of a NOx catalyst for which a smaller reducing agent amount is calculated when executing the rich-spike operations,
wherein a port injector and an in-cylinder injector that are configured so that respective injection ratios of the port injector and the in-cylinder injector with respect to a total fuel amount can be controlled are provided in each cylinder of the internal combustion engine, and
the control means is also configured so that an injection ratio of in-cylinder injectors of a cylinder group that is connected to a NOx catalyst for which a larger reducing agent amount is calculated is higher than an injection ratio of in-cylinder injectors of a cylinder group that is connected to a NOx catalyst for which a smaller reducing agent amount is calculated.

2-5. (canceled)
